(19) United States
(12) Patent Application Publication
(10) Pub. No.: US 2016/0378383 A1
(43) Pub. Date: Dec. 29, 2016

(54) NON-TRANSITORY COMPUTER-READABLE STORAGE MEDIUM, CONCEALMENT DETERMINATION APPARATUS, AND CONCEALMENT DETERMINATION METHOD

(71) Applicant: FUJITSU LIMITED, Kawasaki-shi (JP)

(72) Inventors: Naoki Someya, Kawasaki (JP); Hideharu Seto, Kawasaki (JP)

(73) Assignee: FUJITSU LIMITED, Kawasaki-shi (JP)

(21) Appl. No.: 15/189,526

(22) Filed: Jun. 22, 2016

(30) Foreign Application Priority Data
Jun. 29, 2015 (JP) 2015-129395

(51) Int. Cl. G06F 3/06

(52) U.S. Cl. CPC G06F 3/0622; G06F 3/0637; G06F 3/0673

(57) ABSTRACT

A non-transitory computer-readable storage medium that stores a concealment determination program causing a computer to perform a process including determining whether, upon reception of a request to update data stored in a storage unit, the data that is updated is to be concealed based on the updated data, storing a result of the determining in the storage unit in association with the updated data, and determining, upon reception of a request from a device to read out the updated data, whether to return the updated data to the device by referring the result of the determining associated with the updated data.

### CROSS-REFERENCE TO RELATED APPLICATION

This application is based upon and claims the benefit of priority of the prior Japanese Patent Application No. 2015-129395, filed on Jun. 29, 2015, the entire contents of which are incorporated herein by reference.

### FIELD

The embodiments discussed herein are related to a non-transitory computer-readable storage medium, a concealment determination apparatus, and a concealment determination method.

### BACKGROUND

Service providers that provide services to users (also simply referred to as providers) build and operate business systems suitable for applications in order to provide various services to the users.

Such business systems include database systems used to manage, for example, information (hereinafter also referred to as data) input by users. For example, upon reception of a request to read out information (hereinafter also referred to as a read-out request) from a user, such a database system extracts information corresponding to the received read-out request. Then, the database system transmits the extracted information to a requestor of the read-out request.

Pieces of information managed by such a database system may include, for example, information reading of which is not permitted with an access right (hereinafter also simply referred to as a right) of a user who submits the read-out request. In this case, the database system, for example, deletes the information for which the user who has submitted the read-out request does not have the reading right from the information extracted in response to the read-out request to transmit the information resulting from the deletion to the user (hereinafter also referred to as concealment of information). With this method, the database system is capable of processing the requests to read out pieces of information from multiple users having different rights.

### SUMMARY

According to an aspect of the invention, A non-transitory computer-readable storage medium that stores a concealment determination program causing a computer to perform a process including determining whether, upon reception of a request to update data stored in a storage unit, the data that is updated is to be concealed based on the updated data, storing a result of the determining in the storage unit in association with the updated data, and determining, upon reception of a request from a device to read out the updated data, whether to return the updated data to the device by referring the result of the determining associated with the updated data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the entire configuration of an information processing system;

FIG. 2 is a diagram for describing a specific example of concealment of information;

FIG. 3 is a diagram for describing a specific example of the concealment of information;

FIG. 4 is a diagram for describing a specific example of the concealment of information;

FIG. 5 is a diagram for describing an exemplary hardware configuration of an information processing apparatus;

FIG. 6 is a functional block diagram of the information processing apparatus illustrated in FIG. 5;

FIG. 7 is a flowchart for describing the outline of a concealment determination process in a first embodiment;

FIG. 8 is a flowchart for describing the outline of a concealment determination process in the first embodiment;

FIG. 9 is a diagram for describing the outline of the concealment determination processes in FIG. 7 in the first embodiment;

FIG. 10 is a diagram for describing the outline of the concealment determination processes in FIG. 8 in the first embodiment;

FIG. 11 is a flowchart for describing the concealment determination process in detail when the information processing apparatus has received an update request;

FIG. 12 is a flowchart for describing the concealment determination process in detail when the information processing apparatus has received the update request;

FIG. 13 is a flowchart for describing the concealment determination process in detail when the information processing apparatus has received a read-out request;

FIG. 14 is a flowchart for describing the concealment determination process when the information processing apparatus has received a second update request;

FIG. 15 is a diagram for describing a specific example of Step S22;

FIG. 16 is a diagram for describing a specific example of Step S22;

FIG. 17 is a diagram for describing specific examples of first item information, second item information, and comparison information;

FIG. 18 is a diagram for describing a specific example of Step S33;

FIG. 19 is a diagram for describing a specific example of Step S33;

FIG. 20 illustrates a specific example of extracted information;

FIG. 21 is a diagram for describing a specific example of transmission information when concealment has been performed for the extracted information illustrated in FIG. 20;

FIG. 22 is a diagram for describing a specific example of the comparison information after the comparison information illustrated in FIG. 17 is updated;

FIG. 23 is a diagram for describing a specific example of determination result information after the comparison information illustrated in FIG. 17 is updated;

FIG. 24 is a diagram for describing a specific example of the transmission information after the comparison information illustrated in FIG. 17 is updated;

FIG. 25 is a diagram for describing a specific example of the first item information after the first item information illustrated in FIG. 17 is updated;

FIG. 26 is a diagram for describing a specific example of the extracted information after the first item information illustrated in FIG. 17 is updated; and

FIG. 27 is a diagram for describing a specific example of the transmission information after the first item information illustrated in FIG. 17 is updated.

### DESCRIPTION OF EMBODIMENTS

The concealment of information described above is performed, for example, each time a database system receives the read-out request from a user. In addition, the database system may desirably determine whether the concealment of information is to be performed for each piece of information included in the information extracted in response to the read-out request transmitted from the user (for example, for each piece of information stored in each cell).

Accordingly, the processing performance of the database system may be reduced when the read-out request is frequently transmitted from the user or when a large amount of information is extracted in response to the read-out request transmitted from the user (for example, the extracted information includes a large number of records or columns).

In one aspect, it is desirable to suppress the reduction in the processing performance involved in the concealment of information.

[Configuration of Information Processing System]

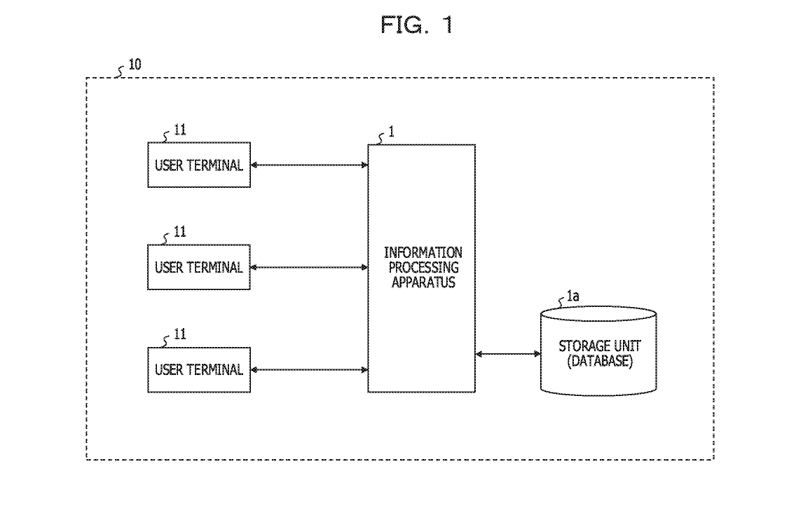

FIG. 1 illustrates an example of the entire configuration of an information processing system 10 (hereinafter also referred to as a database system 10). The information processing system 10 illustrated in FIG. 1 includes an information processing apparatus 1 (hereinafter also referred to as a computer 1 or a concealment determination apparatus 1) and user terminals 11. The user terminals 11 are capable of accessing the information processing apparatus 1. Each of the user terminals 11 is, for example, a terminal used by a user to transmit the read-out request (for example, a request composed of a structured query language (SQL) sentence) to the information processing apparatus 1. The information processing apparatus 1 includes a storage unit is (hereinafter also referred to as a database 1a) that stores, for example, information input by the user with his/her user terminal 11.

Upon reception of the read-out request from the user terminal 11, the information processing apparatus 1 accesses the storage unit 1a to extract information corresponding to the received read-out request. Then, the information processing apparatus 1 transmits the information extracted from the storage unit is to the user terminal 11 from which the read-out request has been transmitted.

When the information processing apparatus 1 has extracted the information corresponding to the read-out request, the information processing apparatus 1 conceals information for which the user who has transmitted the read-out request does not have the reading right, for example, among the pieces of information extracted from the storage unit 1a. The information processing apparatus 1 transmits only information for which the user who has transmitted the read-out request has the reading right, among the pieces of information extracted from the storage unit 1a, to the user terminal 11. The information processing apparatus 1 is capable of permitting the reading of only the information corresponding to the right of the user who has transmitted the read-out request in the above manner. Specific examples of the concealment of information will now be described.

[Specific Examples of Concealment of Information]

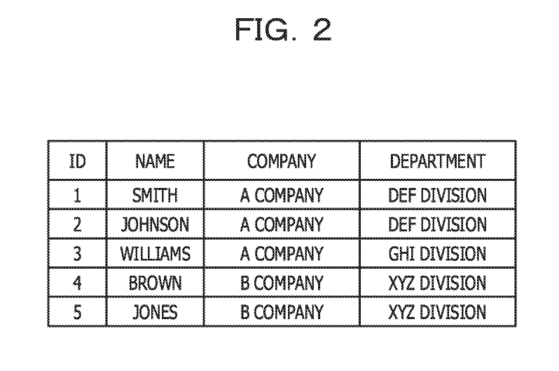

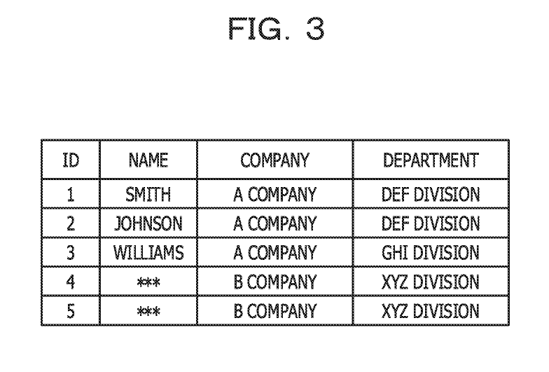

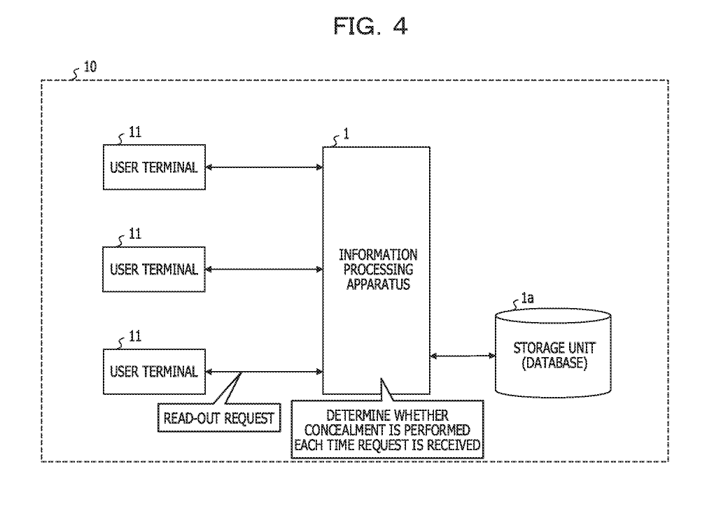

FIG. 2 to FIG. 4 are diagrams for describing specific examples of the concealment of information. Specifically, FIG. 2 is a diagram for describing a specific example of information extracted from the storage unit is by the information processing apparatus 1 (such information is hereinafter also referred to as extracted information). FIG. 3 is a diagram for describing a specific example of information which results from concealment of the information for which the user who has transmitted the read-out request does not have the reading right from the extracted information illustrated in FIG. 2 and which is to be transmitted to the user terminal 11 (such information is hereinafter also referred to as transmission information). FIG. 4 is a diagram for describing a specific example of the read-out request when the concealment of information has been performed.

The extracted information illustrated in FIG. 2 includes “Identifier (ID)” identifying each piece of information included in the extracted information, “NAME” indicating the name of each employee, “COMPANY” indicating the company name of each employee, and “DEPARTMENT” indicating the department to which each employee belongs as items. Specifically, in the extracted information illustrated in FIG. 2, “SMITH” is set as “NAME”, “A COMPANY” is set as “COMPANY”, and “DEF DIVISION” is set as “DEPARTMENT” for the information having “ID” of “1”. A description of the other pieces of information included in the extracted information in FIG. 2 is omitted herein.

Next, the transmission information illustrated in FIG. 3 will be described. It is assumed here that the user who has transmitted the read-out request with his/her user terminal 11 does not have the right to read “NAME” of each employee for which “B COMPANY” is set as “COMPANY”.

In this case, the information processing apparatus 1 sets “****” in “NAME” of the pieces of information for which “B COMPANY” is set as “COMPANY”, for example, in the extracted information described above with reference to FIG. 2. Specifically, in the transmission information illustrated in FIG. 3, “****” is set in “NAME” of the pieces of information having “ID” of “4” and “5”. As a result, the information processing apparatus 1 is capable of permitting the reading of only the pieces of information corresponding to the right of the user who has transmitted the read-out request.

The concealment of information described above is performed, for example, each time the read-out request is received from the user, as illustrated in FIG. 4. In addition, the information processing apparatus 1 may desirably determine whether the concealment of information is to be performed for each piece of information included in the information extracted in response to the read-out request transmitted from the user (for example, for each piece of information stored in each cell).

Accordingly, the processing performance of the information processing apparatus 1 may be reduced when the read-out request is frequently transmitted from the user or when a large amount of information is extracted in response to the read-out request transmitted from the user (for example, the extracted information includes a large number of records or columns).

In order to resolve the above problem, in update of information stored in the storage unit is (such information is hereinafter also referred to as stored information), the information processing apparatus 1 according to the present embodiment determines whether the updated stored information is to be set as a concealment target. In addition, in this case, the information processing apparatus 1 stores information in which the result of the determination is associated with the updated stored information (such information is hereinafter also referred to as determination result information) in the storage unit 1a.

Upon reception of the request to read out the stored information, the information processing apparatus 1 determines whether the stored information corresponding to the read-out request is to be concealed with reference to the result of the determination associated with the stored information corresponding to the read-out request, in the determination result information stored in the storage unit 1a.

In other words, when the stored information has been updated, the information processing apparatus 1 determines whether the updated stored information is to be set as the concealment target and stores the result of the determination in the storage unit 1a. When the request to read out the stored information is received, the information processing apparatus 1 refers to the determination result information. Accordingly, when the request to read out the stored information is received, the information processing apparatus 1 does not determine whether the stored information extracted in response to the read-out request is to be set as the concealment target.

The information processing apparatus 1 does not determine whether the updated stored information is to be set as the concealment target each time the request to read out the stored information is received. Consequently, the information processing apparatus 1 is capable of suppressing the reduction in performance involved in the concealment of information.

[Hardware Configuration of Information Processing Apparatus]

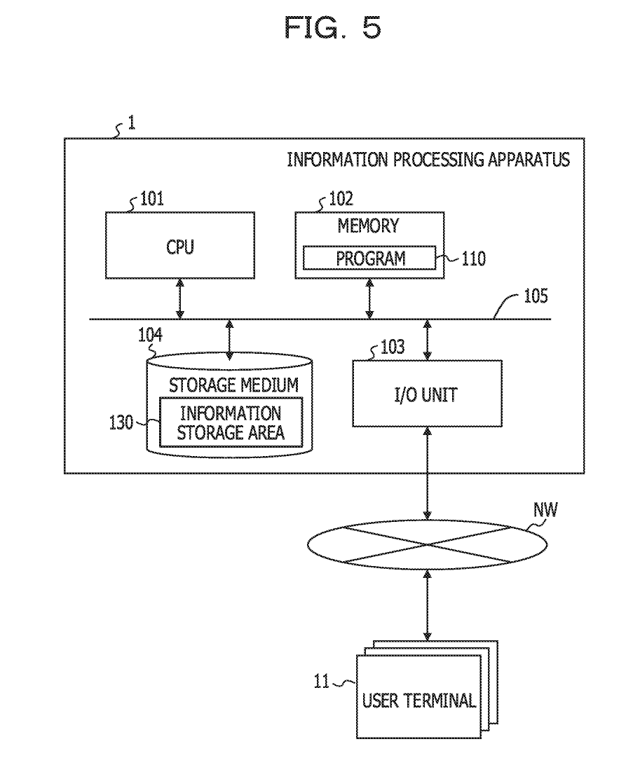

The hardware configuration of the information processing apparatus 1 will now be described. FIG. 5 is a diagram for describing an exemplary hardware configuration of the information processing apparatus 1.

Referring to FIG. 5, the information processing apparatus 1 includes a central processing unit (CPU) 101, which is a processor, a memory 102, an external interface (input-output unit (I/O unit)) 103, and a storage medium (storage) 104. The CPU 101, the memory 102, the external interface 103, and the storage medium 104 are connected to each other via a bus 105.

The storage medium 104 stores a program 110 (hereinafter also referred to as a concealment determination program 110) used to perform a process of determining whether the stored information is to be concealed (such a process is hereinafter also referred to as a concealment determination process) in a program storage area (not illustrated) in the storage medium 104.

The CPU 101 loads the program 110 from the storage medium 104 onto the memory 102 in execution of the program 110 to perform the concealment determination process in cooperation with the program 110, as illustrated in FIG. 5.

The storage medium 104 includes an information storage area 130 (hereinafter also referred to as a storage unit 130) that stores, for example, information used in the concealment determination process. The storage unit is described above with reference to FIG. 1 and so on corresponds to, for example, the information storage area 130.

The external interface 103 communicates with each user terminal 11 via a network NW.

[Software Configuration of Information Processing Apparatus]

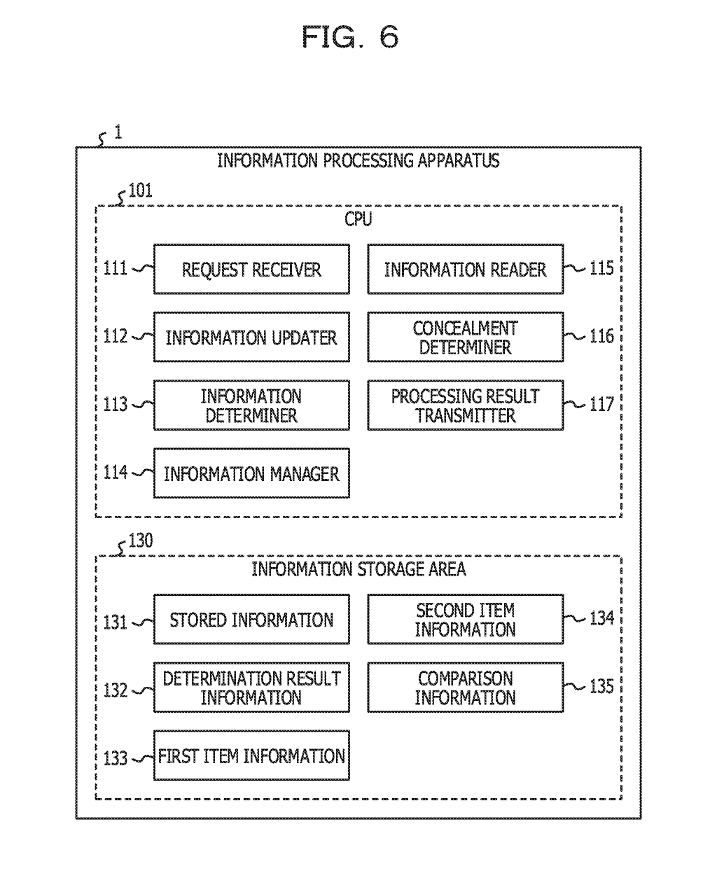

The software configuration of the information processing apparatus 1 will now be described. FIG. 6 is a functional block diagram of the information processing apparatus 1 illustrated in FIG. 5. The CPU 101 operates as a request receiver 111, an information updater 112, an information determiner 113 (hereinafter also referred to as a data determiner 113), and an information manager 114 (hereinafter also referred to as a data manager 114) in cooperation with the program 110. In addition, the CPU 101 operates as an information reader 115, a concealment determiner 116, and a processing result transmitter 117 in cooperation with the program 110. Furthermore, stored information 131, determination result information 132, first item information 133, second item information 134, and comparison information 135 (hereinafter also referred to as comparison data 135) are stored in the information storage area 130.

The request receiver 111 receives the request to read out the stored information 131 stored in the information storage area 130. Specifically, the request receiver 111 receives the request to read out the stored information 131, for example, transmitted from the user with his/her user terminal 11.

In addition, the request receiver 111 receives, for example, a request to update the stored information 131 (hereinafter also referred to as an update request) and a request to delete the stored information 131 (hereinafter also referred to as a deletion request). Furthermore, the request receiver 111 receives, for example, a request to store (add) new information in (to) the information storage area 130 as the stored information 131 (such a request is hereinafter also referred to as a storage request).

When the request receiver 111 has received the update request, the information updater 112 updates the stored information 131 corresponding to the received update request.

The information determiner 113 determines whether, in the update of the stored information 131 by the information updater 112, the updated stored information 131 is to be set as the concealment target in the update transaction. A specific example of the processing by the information determiner 113 will be described below.

The information manager 114 stores the determination result information 132 in the information storage area 130. In the determination result information 132, the result of the determination of whether the updated stored information 131 is to be set as the concealment target is associated with the content of the updated stored information 131. The information manager 114 may store the determination result information 132 in, for example, an external storage apparatus other than the information storage area 130. A specific example of the processing by the information manager 114 will be described below.

When the request receiver 111 has received the read-out request, the information reader 115 reads out (extracts) the stored information 131 corresponding to the received read-out request (including the stored information 131 updated by the information updater 112). A specific example of the processing by the information reader 115 will be described below.

When the information reader 115 has extracted the stored information 131 corresponding to the read-out request, the concealment determiner 116 refers to the result of the determination associated with the stored information 131 extracted by the information reader 115, in the information included in the determination result information 132 stored in the information storage area 130. Then, the concealment determiner 116 determines whether the stored information 131 extracted by the information reader 115 is to be concealed. A specific example of the processing by the concealment determiner 116 will be described below.

The processing result transmitter 117 transmits, for example, the stored information 131 extracted by the information reader 115 to a requestor of the read-out request. In this case, the processing result transmitter 117 conceals the information which the concealment determiner 116 has determined to conceal, in the stored information 131 extracted by the information reader 115, before transmitting the stored information 131 extracted by the information reader 115. In addition, the processing result transmitter 117 transmits, for example, the result of the processing corresponding to the update request or the like received by the request receiver 111 to the requestor of the update request or the like.

The first item information 133, the second item information 134, and the comparison information 135 will be described below.

[Outline of First Embodiment]

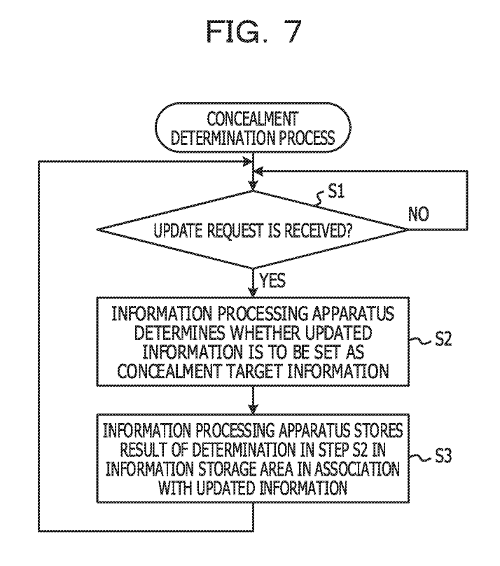

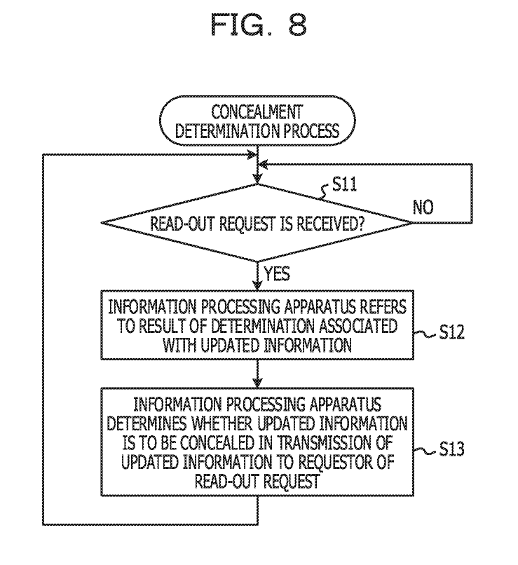

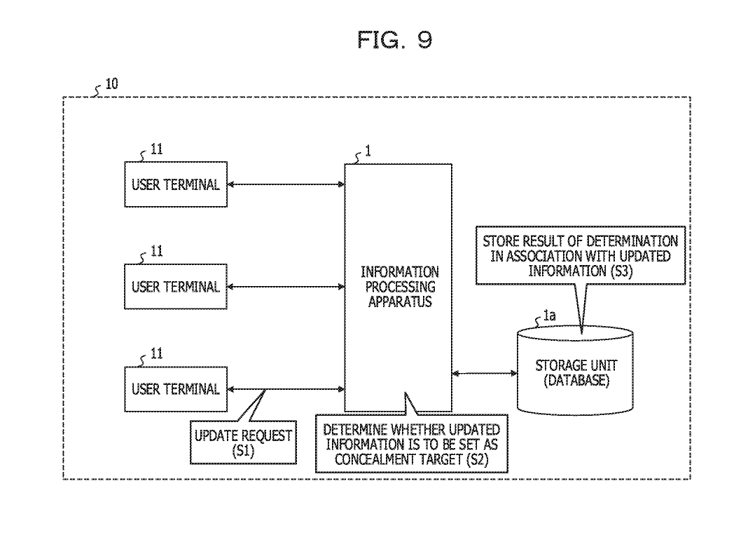

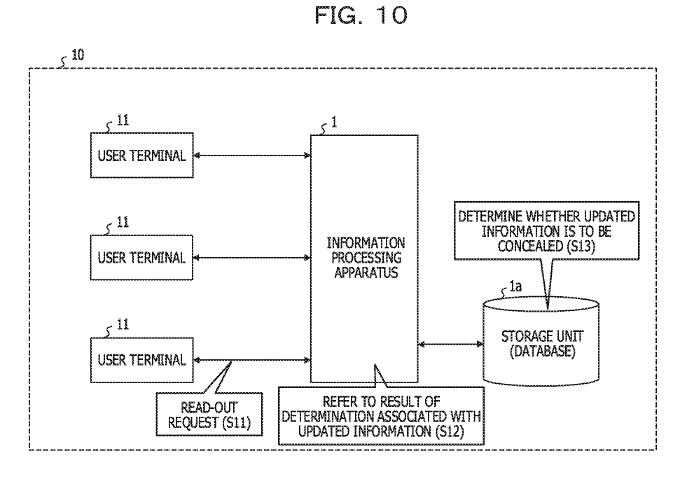

The outline of a first embodiment will now be described. FIG. 7 and FIG. 8 are flowcharts for describing the outline of the concealment determination processes in the first embodiment. FIG. 9 and FIG. 10 are diagrams for describing the outline of the concealment determination processes in the first embodiment. The concealment determination processes in FIG. 7 and the FIG. 8 will now be described with reference to FIG. 9 and FIG. 10.

[Concealment Determination Process When Update Request Has Been Received]

First, the concealment determination process when the information processing apparatus 1 has received the request to update the stored information 131 will be described. FIG. 7 is a flowchart for describing the outline of the concealment determination process when the information processing apparatus 1 has received the update request.

Referring to FIG. 7, in Step S1, the information processing apparatus 1 determines whether the request to update the stored information 131 stored in the information storage area 130 is received. If the information processing apparatus 1 determines that the update request is not received (NO in Step S1), the information processing apparatus 1 waits for reception of the request to update the stored information 131 stored in the information storage area 130. Specifically, the information processing apparatus 1 waits for reception of the update request transmitted from the user with his/her user terminal 11.

If the information processing apparatus 1 determines that the update request is received (YES in Step S1), in Step S2, the information processing apparatus 1 performs the determination of whether the updated stored information 131 (hereinafter also referred to as updated information 131), in the stored information 131 stored in the information storage area 130, is to be set as the concealment target information, as illustrated in FIG. 9. Specifically, the information processing apparatus 1 performs the determination of whether the updated information 131 is to be set as the concealment target information with reference to, for example, the information stored in the information storage area 130 in advance. Specific examples of Step S2 will be described in detail below.

In Step S3, the information processing apparatus 1 stores the determination result information 132 in which the result of the determination in Step S2 is associated with the updated information 131 in the information storage area 130, as illustrated in FIG. 9.

In other words, the information processing apparatus 1 in the present embodiment updates the determination result information 132 stored in the information storage area 130 in association with the update of the stored information 131 stored in the information storage area 130. Accordingly, the information processing apparatus 1 does not perform the determination of whether the stored information 131 corresponding to the read-out request is the concealment target information each time the request to read out the stored information 131 is received, as described below.

[Concealment Determination Process When Read-Out Request Has Been Received]

Next, the concealment determination process when the information processing apparatus 1 has received the request to read out the stored information 131 will be described. FIG. 8 is a flowchart for describing the outline of the concealment determination process when the information processing apparatus 1 has received the read-out request.

Referring to FIG. 8, in Step S11, the information processing apparatus 1 determines whether the request to read out the stored information 131 stored in the information storage area 130 is received. If the information processing apparatus 1 determines that the read-out request is not received (NO in Step S11), the information processing apparatus 1 waits for reception of the request to read out the stored information 131 stored in the information storage area 130. Specifically, the information processing apparatus 1 waits for reception of the read-out request transmitted from the user with his/her user terminal 11.

If the information processing apparatus 1 determines that the read-out request is received (YES in Step S11), in Step S12, the information processing apparatus 1 refers to the result of the determination associated with the updated information 131 corresponding to the read-out request received in Step S11, in the information included in the determination result information 132, as illustrated in FIG. 10. In Step S13, the information processing apparatus 1 performs the determination of whether the updated information 131 is to be concealed in the transmission of the updated information 131 to the requestor of the read-out request, as illustrated in FIG. 10.

In other words, upon reception of the request to read out the stored information 131, the information processing apparatus 1 acquires information indicating whether the stored information 131 corresponding to the read-out request is the concealment target information with reference to the determination result information 132 in which the information is accumulated in advance. Accordingly, the information processing apparatus 1 does not perform the determination of whether the stored information 131 corresponding to the read-out request is the concealment target information each time the request to read out the stored information 131 is received.

Consequently, the information processing apparatus 1 is capable of suppressing the reduction in the processing performance of the information processing apparatus 1 involved in the concealment of information even when the read-out request is frequently transmitted from the user or when a large amount of information is extracted in response to the read-out request.

The determination result information 132 in the present embodiment is stored in the information storage area 130 of the information processing apparatus 1. Accordingly, the update of the determination result information 132 is rapidly performed regardless of which terminal, among the user terminals 11, the update request is transmitted from, unlike a case in which the determination result information 132 is stored in the user terminal 11.

As described above, the information processing apparatus 1 determines whether the updated information 131 is to be set as the concealment target information in the transaction to update the stored information 131 stored in the information storage area 130. In this case, the information processing apparatus 1 stores the result of the determination for the updated information 131 in the information storage area 130 in association with the content of the updated information 131. Upon reception of the request to read out the updated information 131, the information processing apparatus 1 determines whether the updated information 131 is to be concealed with reference to the result of the determination associated with the updated information 131 in the transmission of the updated information 131 to the requestor of the read-out request.

Accordingly, the information processing apparatus 1 does not determine whether the updated stored information is to be set as the concealment target each time the request to read out the stored information is received. Consequently, the information processing apparatus 1 is capable of suppressing the reduction in the performance involved in the concealment of information.

[Detailed Description of First Embodiment]

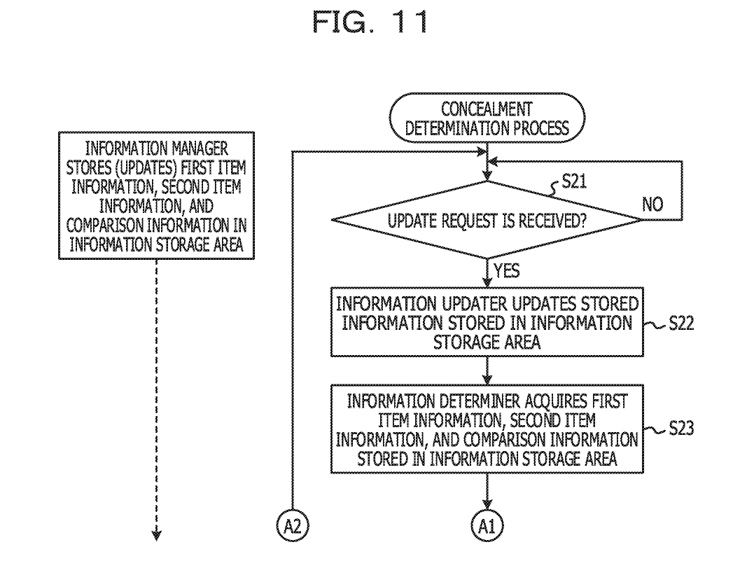

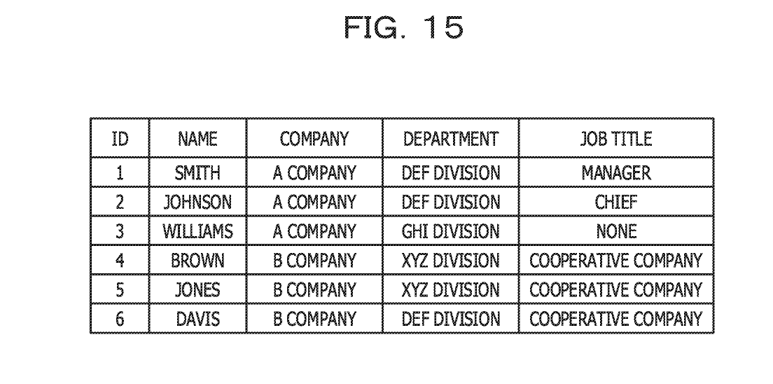

The first embodiment will now be described in detail. FIG. 11 to FIG. 14 are flowcharts for describing the concealment determination processes in the first embodiment in detail. FIG. 15 to FIG. 27 are diagrams for describing the concealment determination processes in the first embodiment in detail. The concealment determination processes in FIG. 11 to FIG. 14 will be described with reference to FIG. 15 to FIG. 27.

[Concealment Determination Process When Update Request Has Been Received]

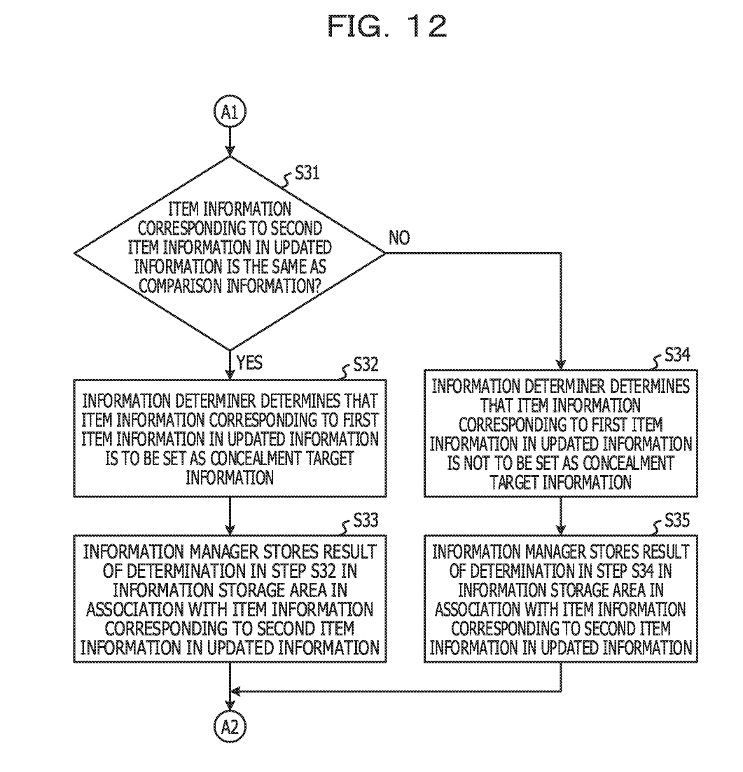

First, the concealment determination process when the information processing apparatus 1 has received the request to update the stored information 131 will be described. FIG. 11 and FIG. 12 are flowcharts for describing the concealment determination process in detail when the information processing apparatus 1 has received the update request.

Referring to FIG. 11, in Step S20, the information manager 114 stores the first item information 133, the second item information 134, and the comparison information 135 in the information storage area 130, as illustrated in a left-side flowchart in FIG. 11. The first item information 133 indicates an item (first item) to which the concealment determiner 116 determines whether the concealment is to be performed, among items included in the stored information 131. The second item information 134 indicates an item (second item) that is referred to in the determination of whether the concealment is to be performed by the concealment determiner 116, among the items included in the stored information 131. The comparison information 135 is referred to in the determination of whether the updated information 131 is to be set as the concealment target by the information determiner 113. Specific examples of the first item information 133, the second item information 134, and the comparison information 135 will be described below.

Specifically, the information manager 114 stores the first item information 133 and so on, for example, before the request receiver 111 starts to receive the read-out request or the update request. The information manager 114 may, for example, update the first item information 133 stored in the information storage area 130 in response to an input or the like of information from the user terminal 11 after the first item information 133 and so on are stored.

In Step S21, the request receiver 111 determines whether the request to update the stored information 131 stored in the information storage area 130 is received, as illustrated in a right-side flowchart in FIG. 11. If the request receiver 111 determines that the update request is not received (NO in Step S21), the request receiver 111 waits for reception of the request to update the stored information 131 stored in the information storage area 130. Specifically, the request receiver 111 waits for reception of the update request, for example, transmitted from the user with his/her user terminal 11.

If the request receiver 111 determines that the update request is received (YES in Step S21), in Step S22, the information updater 112 updates the stored information 131 corresponding to the update request received by the request receiver 111, in the stored information 131 stored in the information storage area 130. The information updater 112 is capable of completing the processing for the update request transmitted from the user terminal 11 in the above manner. Specific examples of Step S22 will now be described.

[Specific Examples of Step S22]

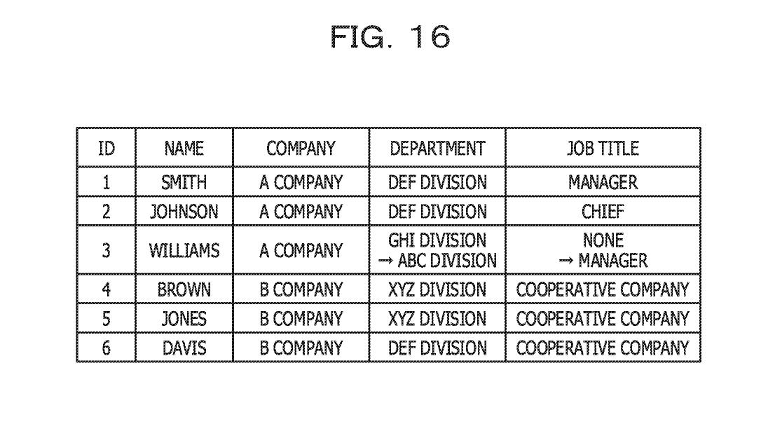

FIG. 15 and FIG. 16 are diagrams for describing specific examples of Step S22. FIG. 15 is a diagram for describing a specific example of the stored information 131 before Step S22 is performed. FIG. 16 is a diagram for describing a specific example of the stored information 131 (including the updated information 131) after Step S22 is performed. The stored information 131 illustrated in FIG. 15 includes “ID” identifying each piece of information included in the stored information 131, “NAME” indicating the name of each employee, “COMPANY” indicating the company name of each employee, and “DEPARTMENT” indicating the department to which each employee belongs as items. In addition, the stored information 131 illustrated in FIG. 15 includes “JOB TITLE” indicating the job title of each employee as an item. In other words, pieces of item information (pieces of item data) each corresponding to one or more items are associated with each other in the stored information 131.

Specifically, in the stored information 131 illustrated in FIG. 15, “SMITH” is set as “NAME”, “A COMPANY” is set as “COMPANY”, “DEF DIVISION” is set as “DEPARTMENT”, and “MANAGER” is set as “JOB TITLE” for the information having “ID” of “1”. A description of the other pieces of information included in the stored information 131 in FIG. 15 is omitted herein.

Next, a specific example of the stored information 131 (including the updated information 131) after Step S22 is performed will be described. A case is described here in which the request receiver 111 has received the update request to update “DEPARTMENT” of the information having “ID” of “3” to “ABC DIVISION” and update “JOB TITLE” thereof to “MANAGER”.

In this case, the information updater 112 updates “DEPARTMENT” of the information having “ID” of “3” from “GHI DIVISION” to “ABC DIVISION” and updates “JOB TITLE” of the information having “ID” of “3” from “None” to “MANAGER”, as illustrated in FIG. 16. The information updater 112 is capable of completing the processing for the update request transmitted from the user terminal 11 in the above manner.

Referring back to FIG. 11, in Step S23, the information determiner 113 acquires the first item information 133, the second item information 134, and the comparison information 135 stored in the information storage area 130. Specific examples of the first item information 133, the second item information 134, and the comparison information 135 will now be described.

[Specific Examples of First Item Information, Second Item Information, and Comparison Information]

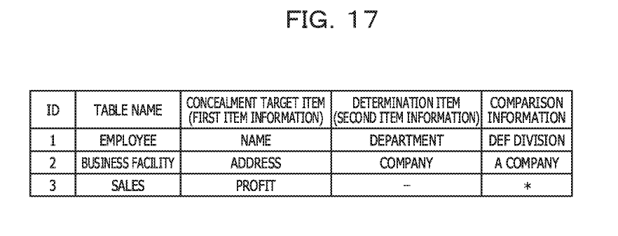

FIG. 17 is a diagram for describing specific examples of the first item information 133, the second item information 134, and the comparison information 135.

The information illustrated in FIG. 17 includes “ID” identifying each piece of information, “TABLE NAME” indicating the name of each table including the stored information 131, “CONCEALMENT TARGET ITEM” corresponding to the first item information 133, “DETERMINATION ITEM” corresponding to the second item information 134, and “COMPARISON INFORMATION” corresponding to the comparison information 135 as items. The first item information 133, the second item information 134, and the comparison information 135 corresponding to the same “ID” are managed in an associated manner. It is assumed here that the stored information 131 described above with reference to FIG. 15 and FIG. 16 has “EMPLOYEE” as “TABLE NAME”.

Specifically, in the information illustrated in FIG. 17, “EMPLOYEE” is set as “TABLE NAME”, “NAME” is set as “CONCEALMENT TARGET ITEM”, “DEPARTMENT” is set as “DETERMINATION ITEM”, and “DEF DIVISION” is set as “COMPARISON INFORMATION” for the information having “ID” of “1”. Accordingly, for example, when the stored information 131 having “EMPLOYEE” as “TABLE NAME” is updated and the information corresponding to “DEPARTMENT” of the updated information is “DEF DIVISION”, the information determiner 113 determines that the information corresponding to “NAME” of the updated information is to be set as the concealment target.

In addition, in the information illustrated in FIG. 17, “BUSINESS FACILITY” is set as “TABLE NAME”, “ADDRESS” is set as “CONCEALMENT TARGET ITEM”, “COMPANY” is set as “DETERMINATION ITEM”, and “A COMPANY” is set as “COMPARISON INFORMATION” for the information having “ID” of “2”. Accordingly, for example, when the stored information 131 having “BUSINESS FACILITY” as “TABLE NAME” is updated and the information corresponding to “COMPANY” of the updated information is “A COMPANY”, the information determiner 113 determines that the information corresponding to “ADDRESS” of the updated information is to be set as the concealment target.

Furthermore, in the information illustrated in FIG. 17, “SALES” is set as “TABLE NAME”, “PROFIT” is set as “CONCEALMENT TARGET ITEM”, blank is set in “DETERMINATION ITEM”, and “*” indicating all the pieces of information is set as “COMPARISON INFORMATION” for the information having “ID” of “3”. Accordingly, for example, when the stored information 131 having “SALES” as “TABLE NAME” is updated, the information determiner 113 determines that the information corresponding to “PROFIT” of the updated information is to be set as the concealment target regardless of the content of the updated information.

Referring to FIG. 12, in Step S31, the information determiner 113 determines whether the item information corresponding to the second item information 134 in the updated information 131 is the same as the comparison information 135. If the information determiner 113 determines that the item information corresponding to the second item information 134 in the updated information 131 is the same as the comparison information 135 (YES in Step S31), in Step S32, the information determiner 113 determines that the item information corresponding to the first item information 133, in the updated information 131, is to be set as the concealment target information. In Step S33, the information manager 114 stores the determination result information 132 in which the result of the determination in Step S32 is associated with the item information corresponding to the second item information 134, in the updated information 131, in the information storage area 130.

If the information determiner 113 determines that the item information corresponding to the second item information 134 in the updated information 131 is not the same as the comparison information 135 (NO in Step S31), in Step S34, the information determiner 113 determines that the item information corresponding to the first item information 133, in the updated information 131, is not to be set as the concealment target information. In Step S35, the information manager 114 stores the determination result information 132 in which the result of the determination in Step S34 is associated with the item information corresponding to the second item information 134, in the updated information 131, in the information storage area 130.

In other words, the information determiner 113 determines whether the item information corresponding to the first item information 133, in the updated information 131, is to be set as the concealment target based on the second item information 134 and the comparison information 135 each time the request to update the stored information 131 is received. Accordingly, the concealment determiner 116 does not determine whether the stored information 131 corresponding to the read-out request is to be concealed each time the request to read out the stored information 131 is received, as described below.

After Step S33 or Step S35, the request receiver 111 waits for reception of the next update request (Step S21 in FIG. 11). Specific examples of Step S33 will now be described.

[Specific Examples of Step S33]

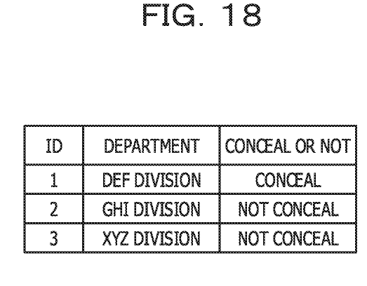

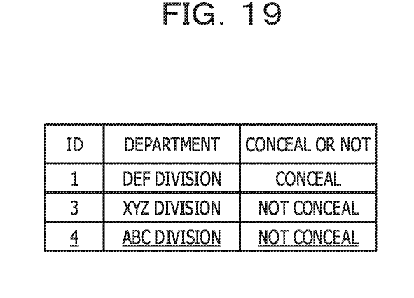

FIG. 18 and FIG. 19 are diagrams for describing specific examples of Step S33. FIG. 18 is a diagram for describing a specific example of the determination result information 132 before Step S33. FIG. 19 is a diagram for describing a specific example of the determination result information 132 after Step S33. The determination result information 132 corresponding to the stored information 131 having “EMPLOYEE” as “TABLE NAME”, in the determination result information 132 stored in the information storage area 130, will be described here.

The determination result information 132 illustrated in FIG. 18 includes “ID” identifying each piece of information included in the determination result information 132 and “DEPARTMENT” to which each employee belongs as items. In addition, the determination result information 132 illustrated in FIG. 18 includes “CONCEAL OR NOT” indicating whether each piece of information is determined to be the concealment target information as an item.

Specifically, in the determination result information 132 illustrated in FIG. 18, “DEF DIVISION” is set as “DEPARTMENT” and “CONCEAL” is set as “CONCEAL OR NOT” for the information having “ID” of “1”. In addition, in the determination result information 132 illustrated in FIG. 18, “GHI DIVISION” is set as “DEPARTMENT” and “NOT CONCEAL” is set as “CONCEAL OR NOT” for the information having “ID” of “2”. Furthermore, in the determination result information 132 illustrated in FIG. 18, “XYZ DIVISION” is set as “DEPARTMENT” and “NOT CONCEAL” is set as “CONCEAL OR NOT” for the information having “ID” of “3”.

In other words, the determination result information 132 illustrated in FIG. 18 indicates that the information having “DEF DIVISION” as “DEPARTMENT”, in the stored information 131 extracted in response to the read-out request when the request to read out the stored information 131 is received, is to be concealed.

A specific example of the determination result information 132 after Step S33 will be described.

As in the example in FIG. 16, the case is described here in which the update request to update the information set in “DEPARTMENT” of the information having “ID” of “3” in the stored information 131 illustrated in FIG. 16 to “ABC DIVISION” and update the information set in “JOB TITLE” thereof to “MANAGER” has been received.

Specifically, in this case, the information determiner 113 adds the information (having “ID” of “4”) having “ABC DIVISION” as “DEPARTMENT” and “NOT CONCEAL” as “CONCEAL OR NOT” to the determination result information 132 (Step S33), as illustrated by underlined portions in FIG. 19.

The information determiner 113 is capable of updating the determination result information 132 in association with the update of the stored information 131 in the above manner. When the request receiver 111 has received the request to read out the stored information 131, the concealment determiner 116 is capable of determining whether the stored information 131 corresponding to the read-out request is to be concealed with reference to the determination result information 132.

The information determiner 113 may confirm whether the information having “GHI DIVISION” as “DEPARTMENT” does not exist in the stored information 131 illustrated in FIG. 16 in Step S33. In this case, the information determiner 113 deletes the information having “GHI DIVISION” as “DEPARTMENT” (the information having “ID” of “2” in FIG. 18) from the determination result information 132, as illustrated in FIG. 19.

The case is described in the above example in which the information determiner 113 determines whether the item information corresponding to the second item information 134 in the updated information 131 is the same as the comparison information 135. However, the information determiner 113 may perform the determination based on another condition in Step S31.

[Concealment Determination Process When Read-Out Request Has Been Received]

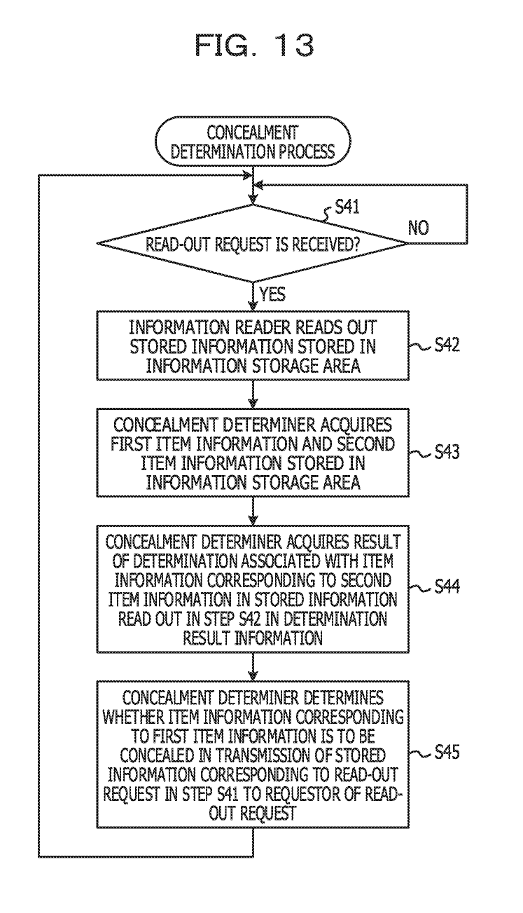

Next, the concealment determination process when the information processing apparatus 1 has received the request to read out the stored information 131 will be described. FIG. 13 is a flowchart for describing the concealment determination process in detail when the information processing apparatus 1 has received the read-out request.

Referring to FIG. 13, in Step S41, the request receiver 111 determines whether the request to read out the stored information 131 stored in the information storage area 130 is received. If the request receiver 111 determines that the read-out request is not received (NO in Step S41), the request receiver 111 waits for reception of the request to read out the stored information 131 stored in the information storage area 130. Specifically, the request receiver 111 waits for reception of the read-out request, for example, transmitted from the user with his/her user terminal 11.

If the request receiver 111 determines that the read-out request is received (YES in Step S41), in Step S42, the information reader 115 reads out (extracts) the stored information 131 corresponding to the read-out request in the stored information 131 stored in the information storage area 130. A specific example of the extracted information extracted in response to the read-out request will now be described. It is assumed here that the read-out request to extract the pieces of information set in “NAME” and “JOB TITLE”, in the stored information 131 (the stored information 131 illustrated in FIG. 16) having “EMPLOYEE” as “TABLE NAME”, has been submitted.

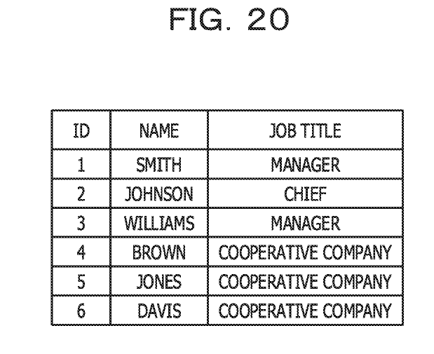

FIG. 20 illustrates a specific example of the extracted information. The extracted information illustrated in FIG. 20 includes “NAME” indicating the name of each employee and “JOB TITLE” indicating the job title of each employee as items. The extracted information illustrated in FIG. 20 also includes “ID” identifying each piece of information included in the extracted information as an item for convenience.

Specifically, in the extracted information illustrated in FIG. 20, “SMITH” is set as “NAME” and “MANAGER” is set as “JOB TITLE” for the information having “ID” of “1”. A description of the other pieces of information included in the extracted information in FIG. 20 is omitted herein.

Referring back to FIG. 13, in Step S43, the concealment determiner 116 acquires the first item information 133 and the second item information 134 stored in the information storage area 130. Specifically, when information is extracted from the stored information 131 having “EMPLOYEE” as “TABLE NAME” in Step S42, the concealment determiner 116 acquires “NAME” as the first item information 133 and “DEPARTMENT” as the second item information 134 with reference to the information in FIG. 17, as in Step S23 in FIG. 11.

In Step S44, the concealment determiner 116 acquires the result of the determination associated with the item information corresponding to the second item information 134 extracted in Step S43, in the stored information 131 read out in Step S42, with reference to the determination result information 132 stored in the information storage area 130. In Step S45, the concealment determiner 116 determines whether the item information corresponding to the first item information 133 is to be concealed in the transmission of the stored information 131 corresponding to the read-out request in Step S41 to the requestor of the read-out request.

Specifically, when the second item information 134 extracted in Step S43 is “DEPARTMENT”, the concealment determiner 116 acquires “DEF DIVISION, which is the information set in “DEPARTMENT” in the information having “ID” of “1”, with reference to the stored information 131 illustrated in FIG. 16. Then, the concealment determiner 116 determines that the information set in “CONCEAL OR NOT” of the information having “DEF DIVISION” as “DEPARTMENT” is “CONCEAL” with reference to the determination result information 132 illustrated in FIG. 18. As a result, the concealment determiner 116 determines that “SMITH”, which is the information set in “NAME” corresponding to “DEPARTMENT” of “DEF DIVISION” in the extracted information illustrated in FIG. 20, is to be concealed.

Similarly, the concealment determiner 116 determines whether the pieces of information set in “NAME” in the extracted information illustrated in FIG. 20 are to be concealed also for the pieces of information having “ID” of “2” to “6” included in the stored information 131 illustrated in FIG. 16.

The processing result transmitter 117 transmits, for example, the information (the transmission information) in which the information about the concealment determined in Step S45 is reflected in the extracted information extracted in Step S42 to the requestor of the read-out request. A specific example of the transmission information will now be described.

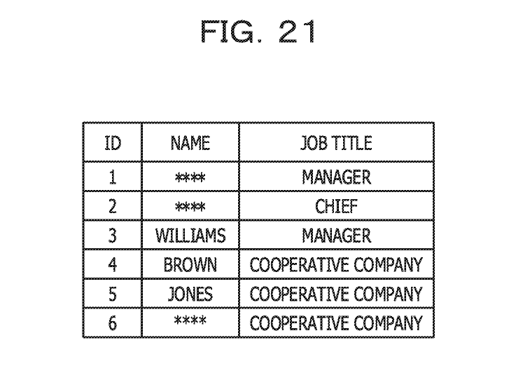

FIG. 21 is a diagram for describing a specific example of the transmission information when the concealment has been performed for the extracted information illustrated in FIG. 20. In the transmission information illustrated in FIG. 21, “****” is set in “NAME” of the pieces of information having “ID” of “1”, “2”, and “6”, unlike the extracted information illustrated in FIG. 20. With the transmission information illustrated in FIG. 21, the processing result transmitter 117 is capable of transmitting the transmission information, which is the information in a state in which the information that is desirably concealed is concealed, to the requestor of the read-out request.

The concealment determiner 116 may identify an area (an area included in the information storage area 130) where the information to be acquired in the determination result information 132 is stored, for example, using a hash function that uses the information set in “DEPARTMENT” in the determination result information 132 as an input. In this case, the concealment determiner 116 is capable of rapidly acquiring the information even when a large amount of information is included in the determination result information 132.

[Concealment Determination Process When Second Update Request Has Been Received]

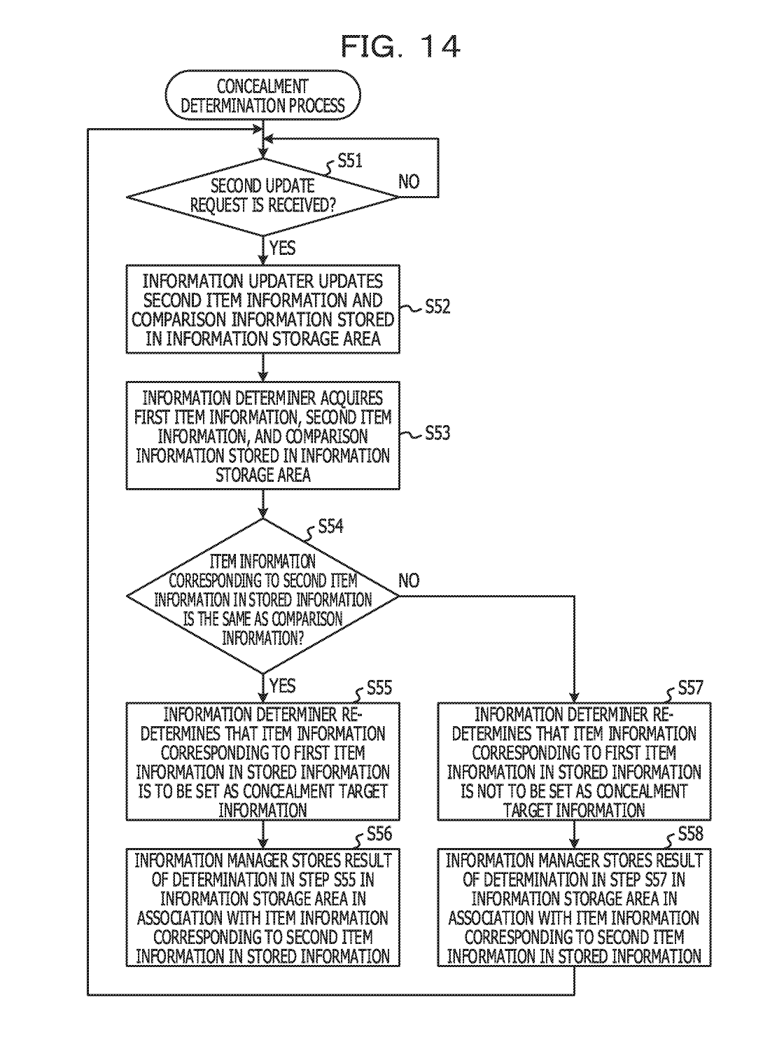

The concealment determination process when the information processing apparatus 1 has received a request to update the second item information 134 or the comparison information 135 (this request is hereinafter also referred to as a second update request) will now be described. FIG. 14 is a flowchart for describing the concealment determination process when the information processing apparatus 1 has received the second update request.

Referring to FIG. 14, in Step S51, the request receiver 111 determines whether the second update request to update the second item information 134 or the comparison information 135 stored in the information storage area 130 is received. If the request receiver 111 determines that the second update request is not received (NO in Step S51), the request receiver 111 waits for reception of the second update request to update the second item information 134 or the comparison information 135 stored in the information storage area 130. Specifically, the request receiver 111 waits for reception of the second update request, for example, transmitted from the user with his/her user terminal 11. If the request receiver 111 determines that the second update request is received (YES in Step S51), in Step S52, the information updater 112 updates the second item information 134 and the comparison information 135 sored in the information storage area 130.

In Step S53, the information determiner 113 acquires the first item information 133, the second item information 134, and the comparison information 135 stored in the information storage area 130. In Step S54, the information determiner 113 determines whether, for example, the item information corresponding to the second item information 134 in the stored information 131 stored in the information storage area 130 is the same as the comparison information 135 stored in the information storage area 130.

In other words, when the second item information 134 or the comparison information 135 is updated, the information determiner 113 and the information manager 114 desirably update the determination result information 132 stored in the information storage area 130 (the determination result information 132 corresponding to the update information based on the second update request). Accordingly, the information determiner 113 and the information manager 114 recreate the determination result information 132 based on the second item information 134 and the comparison information 135 after the update.

If the information determiner 113 determines that the item information corresponding to the second item information 134 in the stored information 131 is the same as the comparison information 135 (YES in Step S54), in Step S55, the information determiner 113 re-determines that the item information corresponding to the first item information is to be set as the concealment target for the information in which the item information corresponding to the second item information 134 is the same as the comparison information 135, in the stored information 131 corresponding to the update information based on the second update request. In Step S56, the information manager 114 stores in the information storage area 130 the determination result information 132 in which the result of the determination in Step S55 is associated with the item information corresponding to the second item information 134 in the stored information 131.

If the information determiner 113 determines that the item information corresponding to the second item information 134 in the stored information 131 is not the same as the comparison information 135 (NO in Step S54), in Step S57, the information determiner 113 re-determines that the item information corresponding to the first item information is not to be set as the concealment target for the information in which the item information corresponding to the second item information 134 is not the same as the comparison information 135, in the stored information 131 corresponding to the update information based on the second update request. In Step S58, the information manager 114 stores in the information storage area 130 the determination result information 132 in which the result of the determination in Step S57 is associated with the item information corresponding to the second item information 134 in the stored information 131.

The case is described in the above example in which the information determiner 113 determines whether the item information corresponding to the second item information 134 in the stored information 131 is the same as the comparison information 135. However, the first item information 133 may perform the determination based on another condition in Step S54.

[Specific Examples of Step S51 to Step S58]

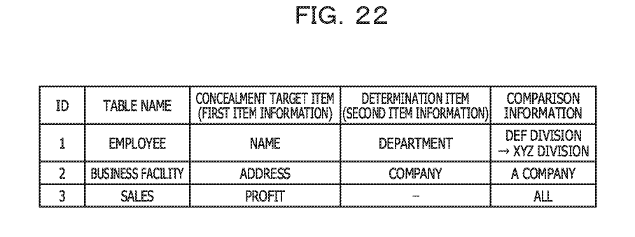

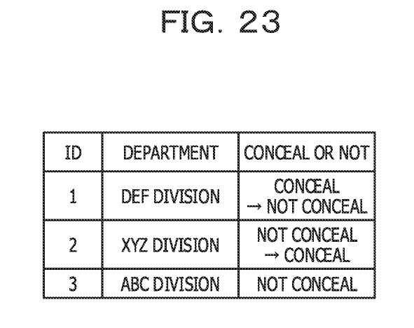

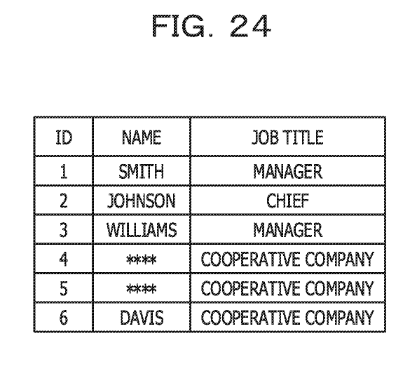

Specific examples of Step S51 to Step S58 will now be described. Specifically, specific examples when the request receiver 111 has received the second update request to update the comparison information 135 will be described. FIG. 22 is a diagram for describing a specific example of the comparison information 135 after the comparison information 135 illustrated in FIG. 17 is updated. FIG. 23 is a diagram for describing a specific example of the determination result information 132 after the comparison information 135 illustrated in FIG. 17 is updated. FIG. 24 is a diagram for describing a specific example of the transmission information after the comparison information 135 illustrated in FIG. 17 is updated.

As illustrated in the comparison information 135 in FIG. 22, the information updater 112 updates the comparison information 135 having “ID” of “1” from “DEF DIVISION” to “XYZ DIVISION” based on, for example, the content of the second update request received by the request receiver 111 (Step S52).

In this case, the information determiner 113 acquires, for example, “NAME” as the first item information 133, “DEPARTMENT” as the second item information 134, and “XYZ DIVISION” as the comparison information 135 with reference to the information illustrated in FIG. 22 (Step S53).

The information determiner 113 re-determines that, for example, the pieces of information having “XYZ DIVISION” as “DEPARTMENT” (the pieces of information having “ID” of “4” and “5”), in the stored information 131 illustrated in FIG. 16, are the pieces of concealment target information (YES in Step S54, Step S55). In contrast, the information determiner 113 re-determines that, for example, the pieces of information that do not have “XYZ DIVISION” as “DEPARTMENT” (the pieces of information having “ID” of “1”, “2”, “3”, and “6”), in the stored information 131 illustrated in FIG. 16, are not the pieces of concealment target information (NO in Step S54, Step S57).

Then, the information manager 114 updates, for example, the determination result information 132 illustrated in FIG. 19. Specifically, the information manager 114 updates “CONCEAL OR NOT” of the information having “DEF DIVISION” as “DEPARTMENT” (the information having “ID” of “1”) from “CONCEAL” to “NOT CONCEAL” and updates “CONCEAL OR NOT” of the information having “XYZ DIVISION” as “DEPARTMENT” (the information having “ID” of “3”) from “NOT CONCEAL” to “CONCEAL”, as illustrated in FIG. 23.

When the read-out request is received from the user terminal 11, the concealment determiner 116 is capable of performing the determination about the concealment based on the determination result information 132 updated in accordance with the update of the comparison information 135 in the above manner, as illustrated in FIG. 24. Specifically, in the transmission information illustrated in FIG. 24, the pieces of information set in “NAME” of the pieces of information having “ID” of “4” and “5” are concealed.

[Concealment Determination Process When Third Update Request Has Been Received]

The concealment determination process when the information processing apparatus 1 has received a request to update the first item information 133 (this request is hereinafter also referred to as a third update request) will now be described.

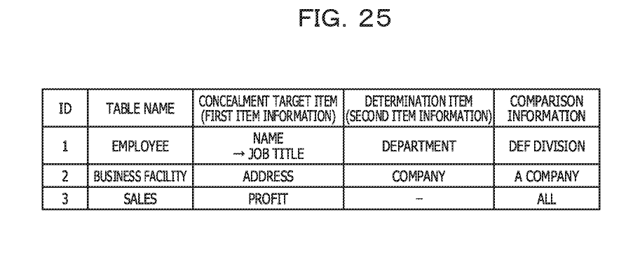

FIG. 25 is a diagram for describing a specific example of the first item information 133 after the first item information 133 illustrated in FIG. 17 is updated. Specifically, in the information illustrated in FIG. 25, the first item information 133 about the information having “ID” of “1” is updated from “NAME” to “JOB TITLE”.

The determination result information 132 described above with reference to FIG. 18 and so on is the information corresponding to the content of the second item information 134 and the content of the comparison information 135. Accordingly, the information determiner 113 and the information manager 114 do not update the determination result information 132 when the first item information 133 has been updated in the manner illustrated in FIG. 25.

A specific example when the request receiver 111 receives the read-out request after the first item information 133 is updated will now be described. It is assumed here that, after the first item information 133 is updated, the request receiver 111 receives the read-out request to read out the pieces of information set in “NAME” and “JOB TITLE” from the stored information 131 illustrated in FIG. 16.

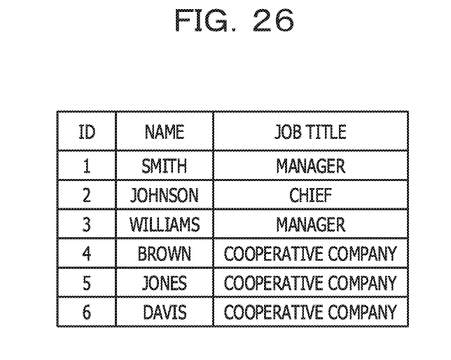

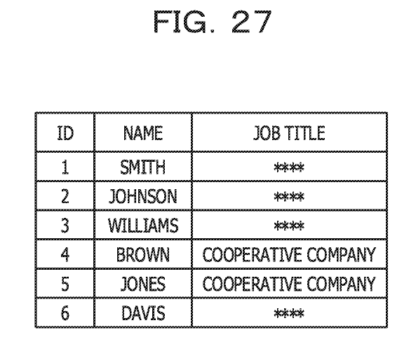

FIG. 26 is a diagram for describing a specific example of the extracted information after the first item information 133 illustrated in FIG. 17 is updated. FIG. 27 is a diagram for describing a specific example of the transmission information after the first item information 133 illustrated in FIG. 17 is updated.

Specifically, the extracted information illustrated in FIG. 26 includes the pieces of information corresponding to “NAME” and “JOB TITLE” in the stored information 131 illustrated in FIG. 16. The extracted information illustrated in FIG. 26 also includes the information corresponding to “ID” identifying each piece of information included in the extracted information for convenience.

The concealment determiner 116 acquires “JOB TITLE” as the first item information 133 and “DEPARTMENT” as the second item information 134 with reference to the information in FIG. 25 (Step S43). In addition, the concealment determiner 116 acquires “DEF DIVISION”, which is the information set in “DEPARTMENT” in the information having “ID” of “1”, with reference to the stored information 131 illustrated in FIG. 16. Furthermore, the concealment determiner 116 determines that the information set in “CONCEAL OR NOT” in the information having “DEF DIVISION” as “DEPARTMENT” is “CONCEAL” with reference to, for example, the determination result information 132 illustrated in FIG. 19. As a result, the concealment determiner 116 determines that “MANAGER”, which is the information set in “JOB TITLE” corresponding to “DEPARTMENT” of “DEF DIVISION”, in the extracted information illustrated in FIG. 26, is to be concealed.

Similarly, the concealment determiner 116 determines whether the pieces of information set in “JOB TITLE” in the extracted information illustrated in FIG. 26 are to be concealed also for the pieces of information having “ID” of “2” to “6” included in the stored information 131 illustrated in FIG. 16.

As illustrated in FIG. 27, “****” is set in “JOB TITLE” of the pieces of information having “ID” of “1”, “2”, and “6” in the extracted information illustrated in FIG. 26. Accordingly, the processing result transmitter 117 is capable of transmitting the transmission information, which is the information in the state in which the information that is desirably concealed is concealed, to the requestor of the read-out request.

As described above, the information processing apparatus 1 determines whether the updated information 131 is to be set as the concealment target information in the transaction to update the stored information 131 stored in the information storage area 130. In addition, the information processing apparatus 1 stores the result of the determination for the updated information 131 in the information storage area 130 in association with the content of the updated information 131. Upon reception of the request to read out the updated information 131, the information processing apparatus 1 determines whether the updated information 131 is to be concealed in the transmission of the updated information 131 to the requestor of the read-out request with reference to the result of the determination associated with the updated information 131.

With the above method, the information processing apparatus 1 does not determine whether the updated stored information is to be concealed each time the request to read out the stored information is received. Accordingly, the information processing apparatus 1 is capable of suppressing the reduction in the performance of the information processing apparatus 1 involved in the concealment of information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium that stores a concealment determination program causing a computer to perform a process comprising:
determining whether, upon reception of a request to update data stored in a storage unit, the data that is updated is to be concealed based on the updated data;
storing a result of the determining in the storage unit in association with the updated data; and
determining, upon reception of a request from a device to read out the updated data, whether to return the updated data to the device by referring the result of the determining associated with the updated data.

2. The non-transitory computer-readable storage medium according to claim 1,
wherein, in data stored in the storage unit, each of one or more pieces of item data corresponding to each of one or more items are associated with each other, and
wherein the updated data is data in which at least one of the one or more pieces of item data is updated.

3. The non-transitory computer-readable storage medium according to claim 2,
wherein the one or more items include a first item to which the determination of whether to return is performed; and
wherein the process comprises:
determining, in the determining whether data that is updated is to be concealed, whether to return the item data corresponding to the first item in the updated data.

4. The non-transitory computer-readable storage medium according to claim 2,
wherein the one or more items include a second item that is referred to in the determining whether data that is updated is to be concealed; and
wherein the process comprises:
storing, in the storing, the result of the determination in association with the item data corresponding to the second item in the updated data; and
referring, in the determining whether data that is updated is to be concealed, to result of the determining associated with the item data corresponding to the second item in the updated data.

5. The non-transitory computer-readable storage medium according to claim 4,
wherein the storage unit stores comparison data that is referred to in the determination of whether the updated data is to be set as the concealment target data, and
wherein the process comprises:
determining that the updated data is to be concealed when the item data corresponding to the second item in the updated data matches with the comparison data.

6. The non-transitory computer-readable storage medium according to claim 5, the process further comprises:
re-determining whether the data stored in the storage unit is to be concealed when the second item or the comparison data stored in the storage unit is updated; and
wherein a result of the re-determining is stored in association with the item data corresponding to the second item in the data stored in the storage unit.

7. A concealment determination apparatus comprising:
a memory; and
a processor configured to:
determine whether, upon reception of a request to update data stored in the memory, the data that is updated is to be concealed based on the updated data;
store a result of the determining in the memory in association with the updated data; and
determine, upon reception of a request from a device to read out the updated data, whether to return the updated data to the device by referring the result of the determining associated with the updated data.

8. A concealment determination method comprising:
determining whether, upon reception of a request to update data stored in a storage unit, the data that is updated is to be concealed based on the updated data;
storing a result of the determining in the storage unit in association with the updated data; and
determining, upon reception of a request from a device to read out the updated data, whether to return the updated data to the device by referring the result of the determining associated with the updated data.
